(19) United States
(12) Patent Application Publication
(10) Pub. No.: US 2017/0249626 A1
(43) Pub. Date: Aug. 31, 2017

(54) Vehicle Sensor, Detecting Method Thereof And Self Enforcing Pay-By-Phone Parking System Using The Same

(71) Applicant: Frederick Lawrence Michael Marlatt, Bangkok (TH)

(72) Inventor: Frederick Lawrence Michael Marlatt, Bangkok (TH)

(21) Appl. No.: 15/512,834

(22) PCT Filed: Sep. 18, 2014
(86) PCT No.: PCT/CN2014/086812

§ 371 Date: Mar. 20, 2017

(51) Int. Cl. G06Q 20/32; G01V 3/08; G01S 13/08; G08G 1/14; G08G 1/017

(52) U.S. Cl. CPC G06Q 20/3223; G08G 1/149; G08G 1/0175; G01S 13/08; G01V 3/08; G06Q 20/3276; G06Q 20/3278

(57) ABSTRACT

A vehicle presence detecting sensor (10) associated with a defined area, wherein, the sensor (10) comprises a microprocessor (100), and a first detecting module (11), a second detecting module (12), as well as a third module (13), respectively connected to and controlled by the microprocessor (100), wherein, the microprocessor (100) is configured for activating the second detecting module (12) when a change of magnetic field is detected by the first detecting module (11) or activating the third module (13) when the distance measured falls out of the predetermined distance range, and for confirming the presence of a vehicle by comparing the distance measured by the second detecting module (12) with a predetermined distance range, or by matching the value of the detailed change of magnetic field detected by the third module (13), with prestored values. Also, a method of the sensor (10) and a self enforcing pay-by-phone parking system using the sensor (10) are disclosed.

### FIELD OF THE INVENTION

The present invention relates to the technical field of vehicle detecting and parking system, and more particularly to a more precisely vehicle detecting sensor and a self-enforcing pay-by-phone parking system using the vehicle sensor for detecting presence and absence of a vehicle.

### BACKGROUND OF THE INVENTION

The number of vehicles is increasing rapidly; vehicle parking management has become a big problem occurred therein. Conventionally, vehicle parking systems are managed by means of applying parking meters, parking gates and un-enforced pay by phone systems. However, during the whole controlling process, the accuracy of vehicle detecting is still the key problem.

An earlier patent application filed in the name of the applicant of the present application, namely International Patent Publication WO 2007/025364, published on 8 Mar. 2007 relates to a parking meter system where a detector is coupled with a microcontroller for detecting the presence or absence of a vehicle in the associated parking space, and the parking meter has a plurality of monitoring units communicating with a single unit for accepting payment by coin, credit card or both. Such detector can be a plurality of in-ground vehicle sensors and each sensor is marked with a unique identifier such as a number. An example of such as in-ground sensor is the GROUND-HOG™ manufactured by Nu-metrics which is a wireless, self-contained, in-ground traffic monitor which transmits a wireless signal upon detection of a vehicle. Herein the in-ground sensor is substantially based on the technology of vehicle magnetic imaging, that is to say, the in-ground sensor may detect the presence of a vehicle according to the earth's field variation for example the vehicle creates.

Another earlier patent application filed in the name of the applicant of the present application, namely International Patent Publication No. WO2008104053, which was published on 9 Apr. 2008, describes a parking enforcement system for monitoring the parking on exclusive streets with in-ground vehicle detecting sensor. Herein, the vehicle sensing sensor may be of the type manufactured by Honeywell, Numetrics, magnetic or proximity sensors.

These sensors mentioned above are mostly the type of magnetic sensor, and that type of sensor has been in use for well over 20 years. However, due to the magnetic field shifts in the earth or magnetic interference/disturbance, the magnetic sensors above-mentioned may be false triggered, for example by an opening door of a vehicle parked in adjacent parking spaces, or by large vehicles passing by.

Patent US005361070A discloses another type of sensor, Ultra-wideband radar motion sensor, which is based on ultra-wideband (UWB) radar. The UWB operates as a pulse-echo system that clocks the two-way time of flight of a very short electrical pulse. This sensor applies an electrical voltage pulse directly to the antenna instead of a carrier frequency. But the process of receiving and recognizing is complex and also the detecting accuracy is not optimized.

In conclusion, the present detecting sensors, including the magnetic sensor and the radar sensor are all not provided with an optimized detecting accuracy, and it has been reported by NYTimes in 2012 that the present detecting sensor methods have a detecting accuracy rate of no more than 90%. In other words, nearly none of the sensors in the prior art can be used to detect a vehicle properly. That defect may influence most applications of the sensor, such as a pay parking system using the sensor, and result in customer's experience of problems

Therefore, a need thus exists for a vehicle detecting sensor that enables a more effective detecting on vehicle presence.

### SUMMARY OF THE INVENTION

Due to the disadvantages the conventional vehicle detecting sensor, an objective of present invention is to provide a more accurate and reliable vehicle detecting sensor and the detecting method thereof, and further a self enforcing pay-by-phone parking system using the sensor is correspondingly provided.

In one aspect according to the present invention, a vehicle presence detecting sensor associated with a defined area, wherein, the sensor comprises a microprocessor, and a first detecting module, a second detecting module, as well as a third module, respectively connected to and controlled by the microprocessor:

the first detecting module, for detecting any magnetic field change in the defined area and conveying the field change microprocessor;

the second detecting module triggered by the microprocessor when a change of magnetic field is detected, for measuring a distance between an object and the sensor by means of radar telemetering and conveying the distance to the microprocessor;

the third module triggered by the microprocessor when the distance measured falls out of the pre-determined distance range, for further detecting the change of magnetic field and conveying a detailed change of magnetic field to the microprocessor;

the microprocessor, for activating the second detecting module when a change of magnetic field is detected by the first detecting module or activating the third module when the distance measured falls out of the pre-determined distance range, and for conforming the presence of a vehicle by comparing the distance measured by the second detecting module with a predetermined distance range, or by matching the value of the detailed change of magnetic field detected by the third module, with pre-stored values.

In one embodiment according to the invention, the sensor also comprises a saving module triggered by the microprocessor, for saving the magnetic field change detected by the first detecting module, when the distance measured by the second module falls into the pre-determined distance range.

In a further embodiment according to the invention, the sensor also comprises a rest module triggered by the microprocessor, for leading the sensor into a rest mode for a defined period when the presence of a vehicle is determined or no change of magnetic field is detected first detecting module.

In a further embodiment according to the invention, the sensor is an in-ground sensor, and the predetermined distance range is 10 cm-100 cm. In a further embodiment according to the invention the sensor (radar) uses a predetermined range of 0 cm-9.99 cm as a detection range of tampering with the sensor, Tampering can be caused by but not limited to placing an object over the sensor such as a metal plate to attempt to fail the sensor. According to the tampering detection, it is easy to determine whether the sensor is functioning well or in an error. Furthermore, when a tampering is detected, corresponding staff of maintenance can be sent to check and repair the sensor.

In a further embodiment according to the invention, the sensor is provided with an shell that having an upper part as well as a lower part embedded, and the upper part is of a circular arc profiles.

In a further embodiment according to the invention, the sensor also comprises a communication module, by means of which the information of vehicle presence is transmitted outward.

In a further embodiment according to the invention, the communication module is operated in either wired or wireless mode.

In a further embodiment according to the invention, the sensor also comprises an imaging module triggered by the microprocessor, for taking a picture of the vehicle present in the defined area.

In a further embodiment according to the invention, the sensor also comprises a lighting module connected to the imaging module and configured for providing illumination to the imaging module in dark environments.

In a further embodiment according to the invention, the sensor also comprises a power module, for providing power energy for the microprocessor and further for the other modules.

In a further embodiment according to the invention, the power module is a battery or a solar panel.

In a further embodiment according to the invention, the sensor also comprises a further sensing element to detect movement such as a 3 axis analog gyro sensors and/or 3 axis accelerometer module and/or a 3 axis magnetic sensor in case the sensor is moved or taken without permission or because of theft/vandalism. This is a very important feature as many people might try to remove the sensor so their car is not detected by a sensor and avoiding for example paying for parking or paying for violation. when the sensor detects movement, it can alert the central database and the authorities.

In another aspect, a method for detecting vehicle presence by means of the vehicle presence detecting sensor mentioned above is also provided, comprising:

magnetic detecting step: detecting any magnetic field change in the defined area;

radar determining step: measuring a distance between an object and the sensor by means of radar telemetering and determining the presence of a vehicle by comparing the distance measured with a predetermined distance range, when a change of magnetic field is detected;

and a further detecting step: further detecting the change of magnetic field and matching the value of the detected change of magnetic field with pre-stored values so as to determine the presence of a vehicle, when the distance measured falls out of the pre-determined distance range.

In a further embodiment according to the invention, the Radar determining step further includes steps that:

if the distance measured by the sensor falls into the predetermined distance range, the vehicle presence is determined;

if the distance measured falls out of the predetermined distance range, the further detecting step is carried out.

In a further embodiment according to the invention the method further comprises a resting step that the sensor turns into a resting mode for a defined period when no magnetic field change is detected or presence of a vehicle is confirmed either in radar determining step or the further detecting step.

In a further embodiment according to the invention if the distance measured by the sensor falls into the predetermined distance range, the method further comprising steps of saving the detected magnetic field change.

Furthermore, the invention also provided a self enforcing pay-by-phone parking system, controlling a plurality of parking spaces, comprising:

a plurality of vehicle detecting sensor claimed in one of the claims 1-11, each associated with one of the parking spaces for detecting the presence or absence of a vehicle in the parking space, for communicating a signal indicative of the presence or absence of a vehicle in the one of the parking spaces;

a plurality of camera means each associated with one of the parking spaces and each adapted to be focused at the one of the parking spaces in the area of the parking space where the license plate of a parked vehicle is located, for communicating a digital image of the license plate of a parked vehicle;

and a unique identification mark associated with each parking space, for recording information of a vehicle parked in the parking space,

wherein the payment is accomplished through communication between a mobile device with a registered account and the identification mark, and then by the payment confirming of a pre-paid parking period from the server to the mobile device.

In a further embodiment according to the invention, the system comprises communicating means for providing communication access for the server. sensor, identification mark and/or the camera means.

In a further embodiment according to the invention, the system further comprises an account refill station for checking account information of the mobile device and refill money into the account.

In a further embodiment according to the invention, wherein the identification mark includes a stall number as well as a NFC tag and/or a QR code.

In a further embodiment according to the invention, the identification mark is attached on free-standing above ground, or the system further comprises a parking sign arranged adjacently to the corresponding parking space, on which the stall number is exposed on top of the parking sign, and the NFC tag and/or QR code on a lower part of the parking sign.

In a further embodiment according to the invention, two adjacent parking spaces share the same parking sign or a single parking space has its own parking sign.

In a further embodiment according to the invention, a single parking space has its own no parking region and/or two adjacent parking spaces share the same no parking region, which is a designated area between stalls of the front and/or rear of the parked vehicle to improve and ensure the capture of the vehicle's license plate with the camera.

In a further embodiment according to the invention, the camera means includes a first camera provided on the top of the parking sign, for taking a picture of the vehicle.

In a further embodiment according to the invention, the parking sign also comprises a sensor device to detect movement such as a 3 axis analog gyro sensors and/or 3 axis Accelerometer Module and/or 3 axis magnetic sensor in case the parking sign is hit or knocked over by a vehicle and/or is moved or taken without permission or because of theft/vandalism. The structure of the sensor device is a very important feature as many people might try to remove the parking sign so that their car will not be detected by a sensor or photographed by the first camera on the parking sign and they may avoid paying for parking. When the sensor detects movement it can alert the central database and the authorities.

In a further embodiment according to the invention, the parking sign is provided with violation lights, for emitting flashing lights for indicating vehicle violations.

In a further embodiment according to the invention, the camera means includes a in-ground camera puck embedded in ground for taking a picture of the license plate of a parked vehicle.

In a further embodiment according to the invention, the in-ground camera puck is placed in a no-parking region adjacent to each of the parking spaces, and the camera puck is provided with one camera focusing on the respective license plate of singular vehicle or provided with two cameras with two opposite shooting directions each focusing on the respective license plate of two adjacent or vehicles.

In a further embodiment according to the invention, the parking sign is provided with a solar panel for converting solar energy into electricity.

In a further embodiment according to the invention, the parking sign is provided with a communication device to transfer data to the server via wire or wireless connection.

In a further embodiment according to the invention, the server initiates the timer for a predetermined standby interval upon receiving a signal from the vehicle detection sensor that a vehicle is present in the associated parking space, wherein the server initiates the camera means or the camera means initiates itself upon confirmation the vehicle has parked to take an image of the vehicle license palate after expiry of the standby interval without receiving a signal that a payment has been made from the mobile device or pay station.

In a further embodiment according to the invention, the server initiates the timer for a prepaid parking period upon receiving a signal that a payment has been made, the server is adapted to terminate the timing of the prepaid parking period and initiates the camera on the parking sign or the in ground vehicle camera puck to take a picture of the vehicle as a parking violation after the expiration of the prepaid parking period without receiving a signal from the mobile device that a no-fine selection that the payment of expiration time will be debited against the corresponding account automatically has been made.

In a further embodiment according to the invention, before the parking violation is assured, a post-grace period is also provided after the expiration of the prepaid parking period for the user to make payment for extending the parking time.

In a further embodiment according to the invention, the server presents parking regulations of the parking spaces to the mobile device and sends timely alarms or notifications to the mobile device.

In a further embodiment according to the invention, in case of vehicle thefts, when the vehicle was moved and left the parking space, the vehicle sensor sends a message to the server and the server then sends a notification to the mobile device for notification, that the vehicle was moved and left the parking space.

In a further embodiment according to the invention, the server has a stored GPS location of each parking stall associated with the identification mark, for recording the location of the vehicle and presenting the mobile device a map for navigation to the vehicle, upon receiving a signal of locating the vehicle from the mobile device. Or optionally, the mobile device which is provided with GPS function may report the location of the identification mark automatically during the communication between the mobile device and the identification mark.

In a further embodiment according to the invention, the camera puck can also be provided with a module works the same way of the sensor, so that when the camera puck is covered by for example a car, the sensor in the camera puck will timely detected the car.

In a further embodiment according to the invention, the parking sign communicate with the sensor associated with the parking space or the sensor in the camera puck, so as to enforce no parking with the sensor in the camera puck or enforce limited parking with the sensor associated with the parking space.

The present invention possesses advantages and beneficial effects as follows.

The vehicle presence is determined by the sensor according to a method based on magnetic field change by magnetic detecting algorithm and a radar detection as calibration to the magnetic detecting algorithm, and thus the false detection of magnetic detection caused by the magnetic field shifts in the earth or magnetic interference/disturbance is decreased or even eliminated to a certain degree. In addition, the radar sensor (i.e., the second detecting module), as a calibration for the magnetic sensor, also confirms the presence of a vehicle in combination with the magnetic sensor to determine the change in the magnetic field and to determine whether it is a vehicle or just some other object. The radar sensor can also assist to detect tampering and notify if the sensor is able to perform properly. Thus the accuracy of the detecting can be increased, and it can be proved through testing that the accuracy can be improved up to approximately 99.9%.

Furthermore, in the self enforcing pay-by-phone parking system, following advantages is further included:

1). the payment is accomplished through communication between a mobile device with a registered account and the identification mark, and then by the payment confirming from the server to the mobile device;

2). if the user intends to pay for parking, the operation is comparatively simple: via touching or tapping the NFC equipped cell phone to the NFC tag or scanning the QR code, phone logs into the server and uploads the parking information automatically; with the reorganization of registration information of the cell phone, server prompts the user to pay for the parking bill by for example entering the payment password. The payment operation is simple and convenient; compared with other pay-by-phone system, the system in the present invention makes it necessary to identify payment of individual parking stalls thus eliminating the need for the person who is going to park a car to enter a stall number or area as all the other pay by phone systems do as they mainly rely on areas; another great advantage of the system in the invention is the self enforcing feature with the camera means and that there is no need for an officer to go to all the parking stalls and check for the payment of vehicles by entering the license plates of all or unpaid vehicles as all the other pay by phone systems do.

3). together with the more precisely detecting sensor, avoiding interference from other vehicles, especially the large vehicles, such as a truck or the like, theft notification of the sensors and self enforcement by the camera means which can timely capture the pictures of the vehicle which is involved with parking violations, and therefore increase revenues and reduce expenses.

4). the pay-by-phone parking system in the invention is individual stall based instead of being area based, and also provided with functions of vehicle theft alarming, parking regulation notification, grace period time feature the no fine feature which automatically debits against the corresponding account under the choice of the user.

5). compared with the parking gate or coin/cash payment parking system, the enclosed pay-by-phone system is more convenient, and cost-saving for less operating labors as well as machine maintaining, for example regular automatic zero clearing operation;

6). moreover, the enclosed pay-by-phone system even help to the appearance of the streets and roads by eliminating the need for meters.

### BRIEF DESCRIPTION OF THE DRAWINGS

Further advantages and embodiments are apparent from the following description in which reference is made to the appended drawings. In the drawings:

FIG. 1 schematically shows a block diagram of the sensor according to the invention;

FIG. 2 schematically shows a block diagram of a further preferred embodiment of the sensor according to the invention;

FIG. 3 schematically shows a structure of a preferred embodiment of a sensor in FIG. 1;

FIG. 4 schematically shows a structure of a further preferred embodiment of a sensor in FIG. 1;

FIG. 5 schematically shows a flow chart for the operation of the sensor in FIG. 3;

FIG. 6 schematically shows a perspective view of a preferred embodiment of a self enforcing pay-by-phone parking system according to the present invention;

FIG. 7 is a perspective view of a further embodiment of the self enforcing pay-by-phone parking system according to the present invention;

FIG. 8 schematically shows a detail partial view of the self enforcing pay-by-phone parking system in FIG. 7;

FIG. 9 schematically shows a structure of a further preferred embodiment of the self enforcing pay-by-phone parking system in FIG. 8;

FIG. 10 schematically shows a structure of a further preferred embodiment of the self enforcing pay-by-phone parking system in FIG. 8; FIG. 11 schematically shows a preferred embodiment of communication between the mobile device and the identification mark using NFC tag in FIG. 6;

FIG. 12 schematically shows a further preferred embodiment of communication between the mobile device and the identification using a QR code mark in FIG. 6;

FIG. 13 schematically shows a detailed view of the parking sign in FIG. 6;

FIG. 14 schematically shows a detailed electrical connection of a further preferred embodiment of the parking sign according to the invention;

FIG. 15 schematically shows a detailed view of a further preferred embodiment of the parking sign in FIG. 13;

FIG. 16 schematically shows a detailed view of a preferred embodiment of the sticker in FIG. 7.

### DETAILED DESCRIPTION OF THE PREFERRED EMBODIMENT

To further illustrate the principle and structure of the present invention, these and other advantages, aspects and novel features of the present invention, as well as details of the illustrated embodiment thereof, will be more fully understand from the following description and drawings. Accordingly, the scope of various aspects of the present invention should not be limited by the embodiments.

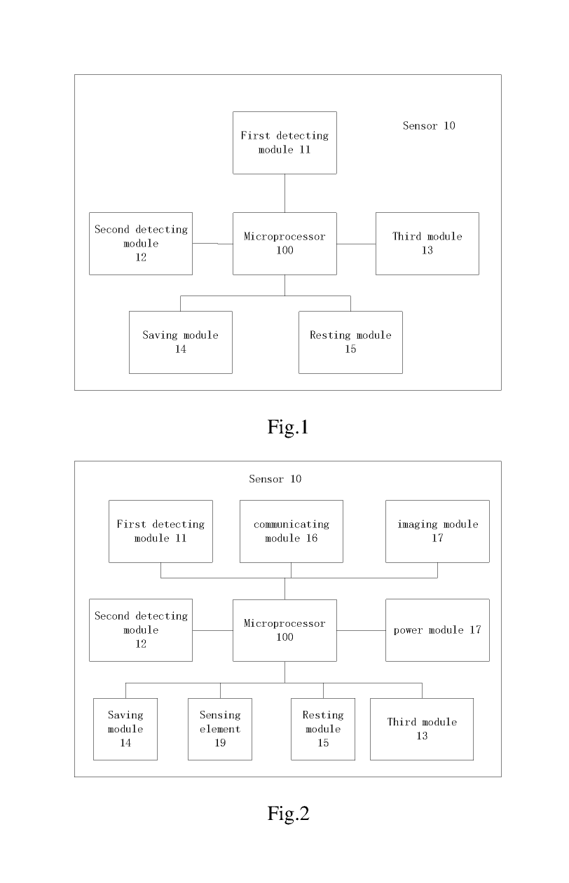

In one embodiment of the present invention, a vehicle presence detecting sensor 10 is provided associated with a defined area, as shown in FIG. 1. The sensor 10 is associated with a defined area, and comprises a microprocessor 100, and a first detecting module 11, a second detecting module 12, as well as a third module 13, and those modules are respectively connected to and controlled by the microprocessor 100. Herein, the first detecting module 11 is configured for detecting any magnetic field change in the defined area, and conveying the field change microprocessor 100. The second detecting module 12 is triggered by the microprocessor 100 when a change of magnetic field is detected, and configured for measuring a distance between an object and the sensor by means of radar telemetering and conveying the distance to the microprocessor 100. The third module 13 is triggered by the microprocessor 100, when the distance measured by the second detecting module 12 falls out of a pre-determined distance range, and configured for further detecting the change of magnetic field and conveying a detailed change of magnetic field to the microprocessor 100.

The microprocessor 100, is configured for activating the second detecting module 12 when a change of magnetic field is detected by the first detecting module 11 or activating the third module 13 when the distance measured falls out of the pre-determined distance range, and for conforming the presence of a vehicle by comparing the distance measured by the second detecting module 12 with the predetermined distance range, or by matching the value of the detailed change of magnetic field detected by the third module 13, with pre-stored values. The vehicle presence can be confirmed, if the distance measured by the second detecting module 12 falls into the predetermined distance range, or if the value of the detailed change of magnetic field matches any of the pre-stored values.

Specifically, once a magnetic field change is detected by the first detecting module 11, the second detecting module 12 is triggered to measure a distance between an object and the sensor by means of radar telemetering, the microprocessor then will confirm the presence of a vehicle by comparing the distance measured with a predetermined distance range. Advantageously, the sensor is an in-ground sensor, and the predetermined distance range is 10 cm-100 cm. If the distance measured by the second detecting module 12 is less than 10 cm, it can be suggest that there might be some interference existing in the area.

Furthermore, the second detecting module 12 (i.e., a radar detecting module) uses a predetermined range of 0 cm-9.99 cm as a detection range of tampering with the sensor, Tampering can be caused by but not limited to be caused by placing an object over the sensor such as a metal plate to attempt to fail the sensor 10.

When the distance measured falls out of the pre-determined distance range, the third module 13 is triggered to further detect the detailed change of magnetic field and then the microprocessor will match the value of the detected change of magnetic field with pre-stored values so as to determine the presence of a vehicle.

Therefore, In addition to the magnetic sensor (i.e., the first detecting module), the radar sensor (i.e., the second detecting module), as a calibration for the magnetic sensor, also confirms the presence of a vehicle in combination with the magnetic sensor to determine the change in the magnetic field and to determine whether it is a vehicle or just some other object. The radar sensor can also assist to detect tampering and notify if the sensor is able to perform properly.

In a further preferred embodiment of the sensor in the invention, a saving module 14 is also provided for storing the pre-stored values. The precise change of magnetic field can be used to classify different types of vehicles-cars, vans, trucks, buses, trailer truck, etc, and therefore the change of magnetic field values can be pre-stored for determining a type of and/or vehicle presence. If the distance measured by the second detecting module 12 falls out of the pre-determined distance range, the reason may be other object, for example if a substantial amount fallen leaves, debris or the like, or many inches of liquid over the top of the sensor may be detected by the second detecting module 12. In case of detection failure of the second detecting module 12, the pre-stored values related to an exact vehicle stored in the storing module can be adopted to further determine the vehicle presence of a vehicle. The second detecting module 12 can detect if itself is in error when the distance measured falls out of the pre-determined distance range, while the first module 11 (magnetic detecting module) cannot determine if itself is in error. Therefore, the present sensor with both the first module 11 and the second module 12, can obtain a comparatively more convincible detecting result. Also, when the a second detecting module 12 has confirmed the presence of a vehicle, the change of magnetic field related to the determined vehicle can be saved into the storing module 14. Additionally, the saving module 14 may also save results of the vehicle presence detecting, wherein the results including information of vehicle presence and/or vehicle absence.

Additionally, to ensure a better performance and energy efficiency of the sensor, the sensor 10 also comprises a resting module 15 connected to the microprocessor, for leading the sensor 10 into a rest mode for a defined period of time; especially when the presence of a vehicle is determined or no change of magnetic field is detected. Preferably, the defined period of time can be a few seconds, for example 2-10 seconds.

As shown in FIG. 2, it is conceivable that the sensor 10 is provided with a communication module 16, by means of which the information of vehicle presence is transmitted outward, wherein the communication module 16 is operated in either wired or wireless mode.

Advantageously, as shown in FIG. 2, the sensor 10 may also comprises an imaging module 17, for example as camera apparatus, triggered by the microprocessor 100, for taking a picture of the vehicle present nearby.

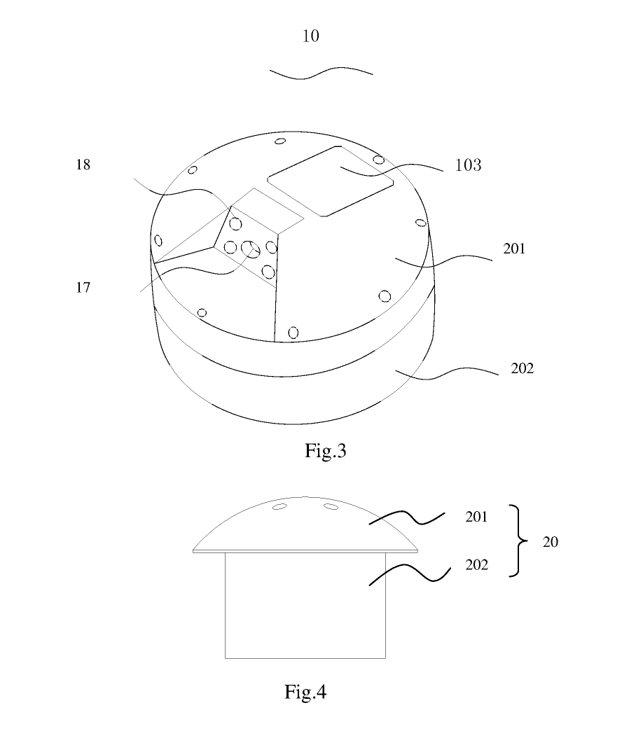

As shown in FIG. 3, conceivably, the sensor 10 also comprises a lighting module 18, for example, LED lights, connected to the microprocessor 100 and configured for providing illumination to the imaging module 17 in dark environments. Additionally, the sensor 10 also comprises a power module 103, for providing power energy for the microprocessor 100 and further for the other modules. Preferably, the power module 103 is a battery or a solar panel.

Furthermore, the sensor 10 advantageously also comprises a further sensing element 19 to detect movement such as a 3 axis analog gyro sensors and/or 3 axis accelerometer module and/or a 3 axis magnetic sensor 10 in case the sensor 10 is moved or taken without permission or because of theft/vandalism. This is a very important feature as many people might try to remove the sensor 10 so their car is not detected by the sensor 10 and avoiding for example paying for parking or paying for violation. when the sensor 10 detects movement, it can alert the central database and the authorities.

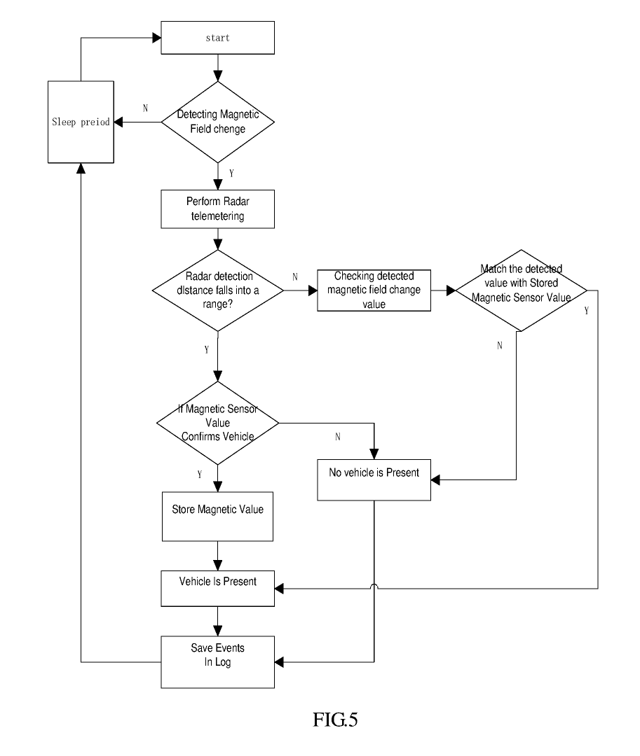

In the case of FIG. 4, the sensor 10 is provided with shell 20 in a shape of a puck, and includes a lower part 202 to be embedded in the ground and an upper part 201 to be exposed on above of the ground. The microprocessor 100 as well as other modules is arranged in the shell 20. Comparing with the one in FIG. 3, the sensor 10 in this embodiment is mushroom-shaped that the diameter of bottom of the upper part 201 is larger than that of the column-shaped lower part 202. Furthermore, to resist damage, the imaging module herein is arranged in a recess/notch defined on lateral surface of the upper part 201. The upper part 201 has a curved surface so that the water or rain drops onto the upper part 201 will flow over the surface along the contour, and therefore water will not pool on the sensor, and the modules and the microprocessor inside the shell will be protected from damage. Moreover, the detecting accuracy of the sensor 10 can be assured. It is conceivable that the sensor 10 shall not be limited to the structures described herein.

FIG. 5 illustrates a method for detecting vehicle presence by means of the vehicle presence detecting sensor shown in any of FIG. 1-4. The method at least comprises steps as follows.

Magnetic detecting step: the first detecting module 11 detects whether any magnetic field change exists in the defined area. If a magnetic field change is detected, turn to radar determining step; if not, trigger the sensor 10 into rest mode.

Radar determining step: the second detecting module 12 measures a distance between an object and the sensor 10 by means of radar telemetering and confirms the presence of a vehicle by comparing the distance measured with a predetermined distance range. If the distance measured falls into of the pre-determined distance range, confirm the presence a vehicle; if the distance measured falls out of the pre-determined distance range, turn to a further detecting step. If the distance measured by the second detecting module 12 falls out of the pre-determined distance range, the reason may be other object, for example if a substantial amount fallen leaves, debris or the like, or many inches of liquid over the top of the sensor may be detected by the second detecting module 12. In case of detection failure of the second detecting module 12, Specifically, the second detecting module 12 (i.e., a radar detecting module) uses a predetermined range of 0 cm-9.99 cm as a detection range of tampering with the sensor, Tampering can be caused by but not limited to be caused by placing an object over the sensor such as a metal plate to attempt to fail the sensor 10.

A further detecting step: the third module 13 further detects the change of magnetic field so that the microprocessor matches the value of the detected change of magnetic field with pre-stored values so as to determine the presence of a vehicle.

Furthermore, the sensor turns into a resting mode for a defined period when presence of a vehicle is determined in Radar determining step/a further detecting step.

Additionally, during the Radar determining step, before the confirming of the presence a vehicle, the method also comprises steps of storing the magnetic change detected by the first detecting module 11 into the saving module 14.

The vehicle presence detecting sensor 10 can be applied into many different applications, and particularly, a self enforcing pay-by-phone parking system using the sensor 10 is disclosed in the present invention.

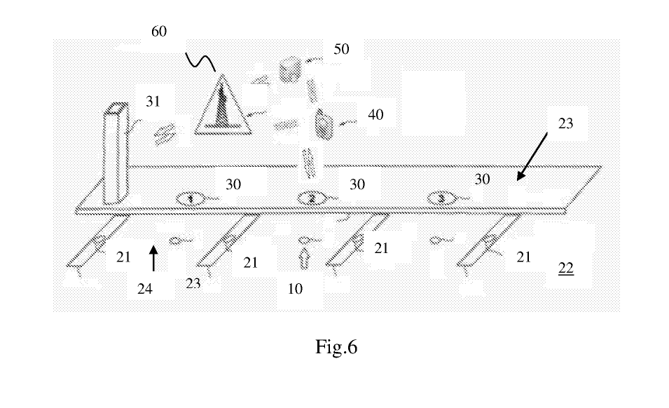

The vehicle presence detecting sensor can be applied into a parking system, in particularly, as shown in FIG. 6; a preferred embodiment of self enforcing pay-by-phone parking system according to the present invention in a municipal street 22 is illustrated. In this case, a curb 28 is formed on an edge of the municipal street 22, and herein a plurality of marked parking spaces 24 is arranged. Each parking space 14 is provided with an in-ground vehicle sensor 10 as well as a unique identification mark 30. On one hand, the identification mark 30 comprises a stall number of the exclusive parking space 24, and on the other hand, the identification mark 30 comprises a recording a NFC tag and/or a QR code (not shown here) for communicating with a mobile device 40. A plurality of camera means 21 each associated with one of the parking spaces 24 respectively and each adapted to be focused at the one of the parking spaces 24 in the area of the parking space where the license plate of a parked vehicle is located, for communicating a digital image of the license plate of a parked vehicle to the server 50. At least the in-ground vehicle sensor 10 is communicated with a server 50 for providing the presence or absence of the vehicle to the server 50. Conceivably, the communication between the in-ground vehicle sensor 10 and the server is either wired or wireless, for example by means of 3G/GPRS/Internet/landline /POE.

As shown in FIG. 6, a municipal street 22 has curb 23 and a plurality of marked parking spaces 24 separated by dividing lines, each with an in-ground vehicle sensor 10. Each space or stall 24 is marked with a unique identification mark 30. The in-ground sensor is a wireless, self-contained, in-ground traffic monitor which transmits a wireless signal upon detection of a vehicle directly to the server 50 through the communication access 60. Associated with each parking space 24 is also an in-ground wireless camera puck 21b which incorporates in housing a digital camera, which optionally may comprise a microcontroller, wired or wireless communication device and battery. The vehicle sensor 10 may work in conjunction with the camera puck 21b to instruct the camera puck 21b that a vehicle is present and to take a picture to improve speed of capturing the picture of the parked vehicle. A solar panel (not shown) may be included to charge the battery. Wireless communication can be via wlan, wifi, Bluetooth, GSM/GPRS, Zigbee, Xbee or other wireless protocol, and the units are addressable with an IP or other address. Also, the camera puck 21b can also be provided with a module works the same way of the sensor 10, i.e., the vehicle sensor 10 and camera puck 21b could be incorporated into a single housing, so that when the camera puck 21b is covered by for example a car, the sensor 10 in the camera puck 21b will timely detected the car, and then the parking sign communicated with the camera puck may alarm the driver to move the car or an officer will be notified and sent to check the situation of the camera puck. In this way, the camera puck 21b can be guaranteed in proper operation situation.

Additionally, the vehicle parking system also include an account refill station 31, in particular an automated storage machine for the driver to check their account information and refill money into the account, especially people without a credit card. In some other conceivable embodiments, users may fulfill the account refilling directly on websites. Optionally, the account refill station 31 can also be used for payment directly by cash or credit card, especially for visitors who have not yet registered in the system.

In this embodiment, the identification mark is attached on free-standing above ground, users may scan the QR code of tap the NPC tag to log in and communicate with the server and then further pay for and select the parking time on the mobile device. The payment is accomplished through communication between the mobile device 40 with a registered account and the identification mark 30, and then by the payment confirming of a pre-paid parking period from the server 50 to the mobile device 40.

The payment can be described in details as follows: as a vehicle is parked in the parking space 24, the sensor 10 operates in the way that FIG. 5 shows above. If the vehicle has been parked at the parking space 24 for more than a few minutes, such as 3 minutes, it can be confirmed that the vehicle is not just passing by, so standby interval, i.e., a pre grace period, is started. During the pre grace period, the camera means 21 will take a picture of the license plate of the vehicle. To make extra certain, at least 3 photos of the vehicle license plate can be acquired. The grace period can be programmable say 1-15 mins. When the grace period has expired, while no payment is confirmed by the server 50, the vehicle violation is verified, and the picture of the vehicle license plate will then be sent to the corresponding server and processing by management. If the payment of a pre-paid parking period is confirmed by the server, the vehicle violation will be decided after expiry of the pre-paid parking period. However, if a no-fine selection that the payment of expiration time will be debited against the corresponding account automatically by the server, the vehicle parked in the parking space shall not be declared a violation. The No Fine feature will stop when the sensor detects that the vehicle has driven away.

In a typical configuration, the pre grace period, for example, up to 1-15 minutes, is provided to allow the driver to exit the vehicle and make payment without issuing a parking violation right away. The server and/or camera puck will be programmed to issue a parking violation and license image capture automatically after a vehicle has been sensed in a parking space and the pre grace period has passed without payment. When the vehicle enters the parking space, the in-ground sensor communicates the presence of the vehicle to camera pucks 21 which takes a digital image of the license plate and commences communication to the server that the vehicle has parked and at what time and any other relevant information to the server 50. A digital image of the license plate may be taken immediately on detection of the vehicle to avoid situations where the license is obscured or not visible when the violation event has occurred. After the server 50 has determined that the pre grace period has been exceeded without payment, then a parking violation is issued using the previously captured image and/or a second newly-captured image. If the vehicle drives away during the pre grace period and does not pay then the camera puck 21b transmits the captured picture to the server 50.

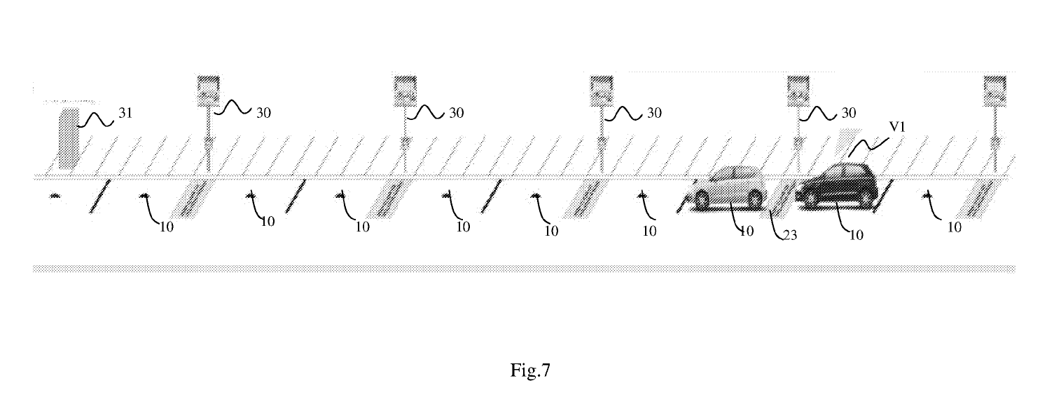

In FIG. 7, a further preferred embodiment of the self enforcing pay-by-phone parking system is illustrated. In this case, the system further comprises a parking sign 30 on which the identification mark is displayed adjacently to the corresponding parking space. Specifically, the stall number 30a is displayed on top of the parking sign, and the NFC tag and/or QR code 30b on a lower part of the parking sign. As is shown in FIG. 7, two adjacent parking spaces share the same parking sign 30, and between those two adjacent parking spaces, a no-parking region 23 is provided corresponding to the parking sign 30. The same as what described in FIG. 6, there are also a plurality of vehicle detecting sensor 10 each associated with one of the parking spaces for detecting the presence or absence of a vehicle v1, v2, v . . . in the parking space, for communicating a signal indicative of the presence or absence of a vehicle in the one of the parking spaces to the parking sign 30 or camera puck 21b or to the server (not illustrated here). Also, the function and specific structure of the sensor 10, the camera puck 21, the server, the mobile device as well as the refill station 31 can refer to the related descriptions of FIG. 6.

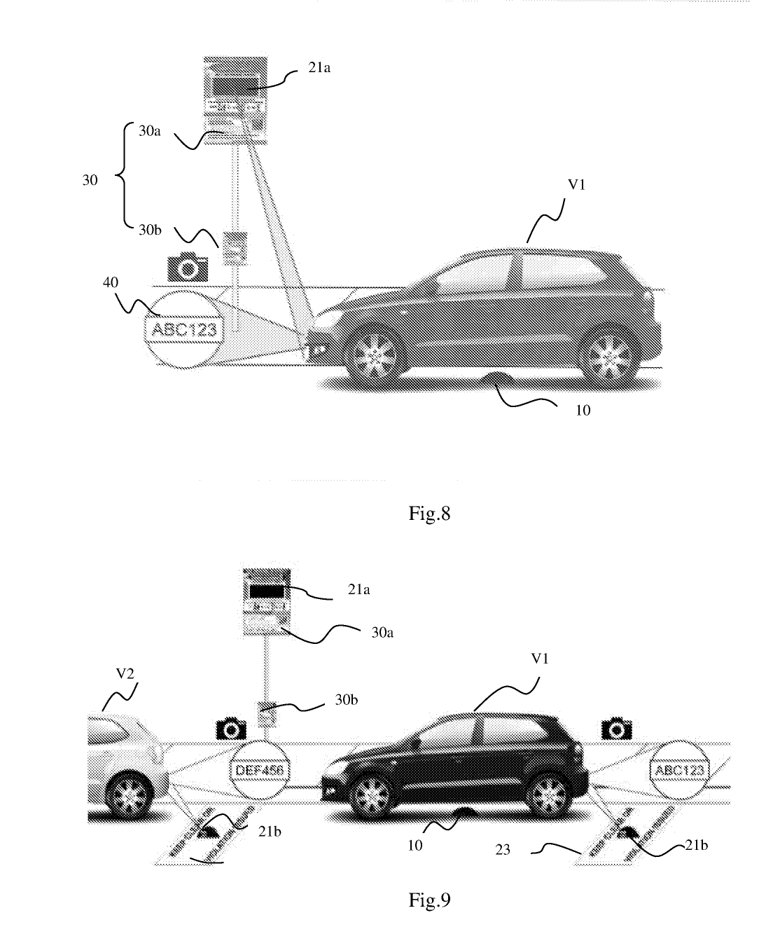

As shown in FIG. 8, it is a detailed view of the parking situation of vehicle V1 in FIG. 7. In this case, the vehicle v1 is parked right above the sensor 10 in the parking space. The parking sign 30 adjacent to the parking space is provided with a first camera 21a on the top of the parking sign, for taking a picture of the vehicle and also at a height not easily to be tampered with. In this way, the camera on the parking sign 30 with a high or low height and or camera pucks 21 in the no parking area between the parking spaces, will work to take pictures all the time. In particularly, the camera 21 focuses on the license plate 41 of the vehicle v1. Also, on top of the parking sign 30, violation lights (not labeled) is provided for emitting flashing lights for indicating vehicle violations and/or notification of no parking. Here, the NFC tag and/or QR code 30b is arranged at a proper height which is suitable for users to scan or tap. The stall number 30a is arranged at a comparative higher height, so that it can be easily seen.

As is shown in FIG. 9, a further preferred embodiment of the case in FIG. 8 is illustrated. The same as FIG. 8, the parking system in FIG. 9 also comprises parking spaces, parking sign as well as sensor. Additionally, a no-parking region 23 is provided between two adjacent parking space. Moreover, an in-ground camera puck 21b is embedded in the no-parking region 23 for taking a picture of the license plate of a parked vehicle. In this case, the camera puck is provided with only one camera which focuses on the license plate of the corresponding vehicle and is used in situations where vehicles only have one license plate on the vehicle as one camera puck 21b must be used per stall. Referring FIG. 9, it can be seen that the camera pucks 21b focus on the license plate on back of the vehicles v1, v2, respectively. This parking system with this kind of camera pucks suits the situation in jurisdictions where vehicles have only a single license plate, and it can be required that a vehicle park in one direction only.

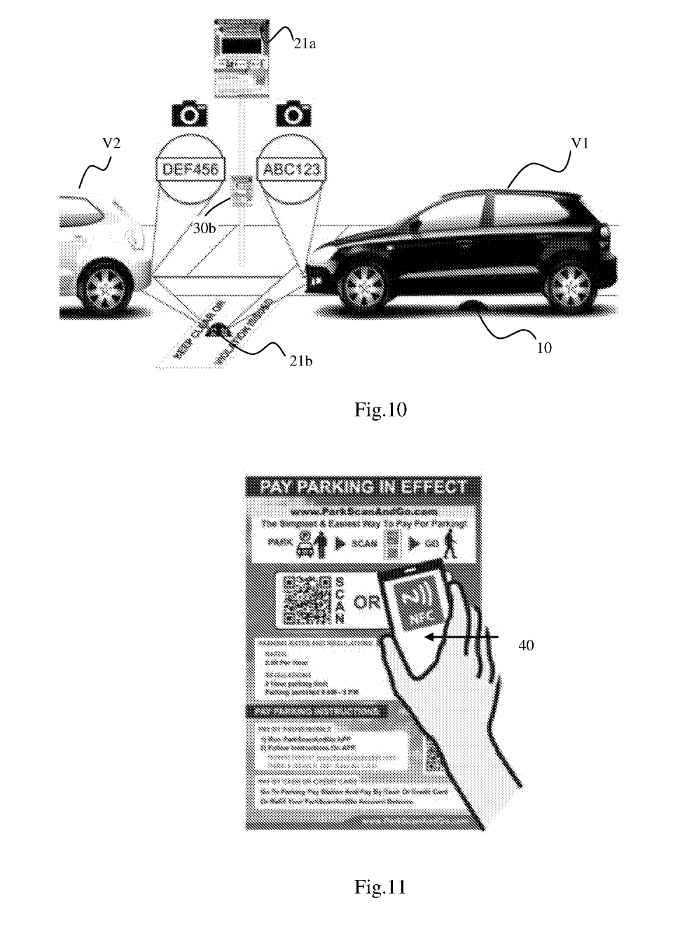

Furthermore, the camera puck 21b is provided two cameras with two opposite shooting directions each focusing on the respective license plate of two adjacent vehicles. Referring to FIG. 10, the camera puck 21b is embedded between two parking spaces where two vehicles v1, v2 are respectively parked, two cameras of the camera puck 21b separately focus on the license plate on back of the vehicle v2 or focus on the license plate in front of the vehicle v1.

Similar with the sensor 10 in FIG. 3, the camera puck 21b has an integrated structure to be embedded in the ground, and may also be provided with for example LED lights to supply illumination to the camera in dark environments. In this case, picture of the vehicle violating captured by the camera puck 21b may further be sent out, in particular to server and be issued as violation through the internet 60. Besides, the camera pucks 21 may be integrated with the sensor 10 so as to monitoring the situation of no-parking space 23, and for taking picture of the vehicles violating parked in the no-parking space 23 especially together with the first camera 21a on the parking sign 30.

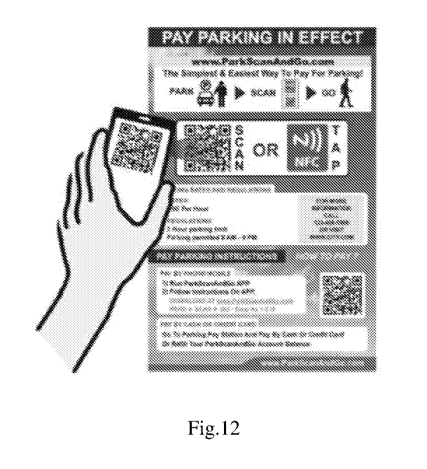

FIG. 11-FIG. 12 illustrate two way of communication between the mobile device and the identification mark. For the mobile device with NFC function, users may tap the NFC tag with the mobile device 40, and the mobile device 40 will obtain information such as the identification mark, stall number and then can log in. Or, the user may obtain information and log in through scanning the QR code by the mobile device.

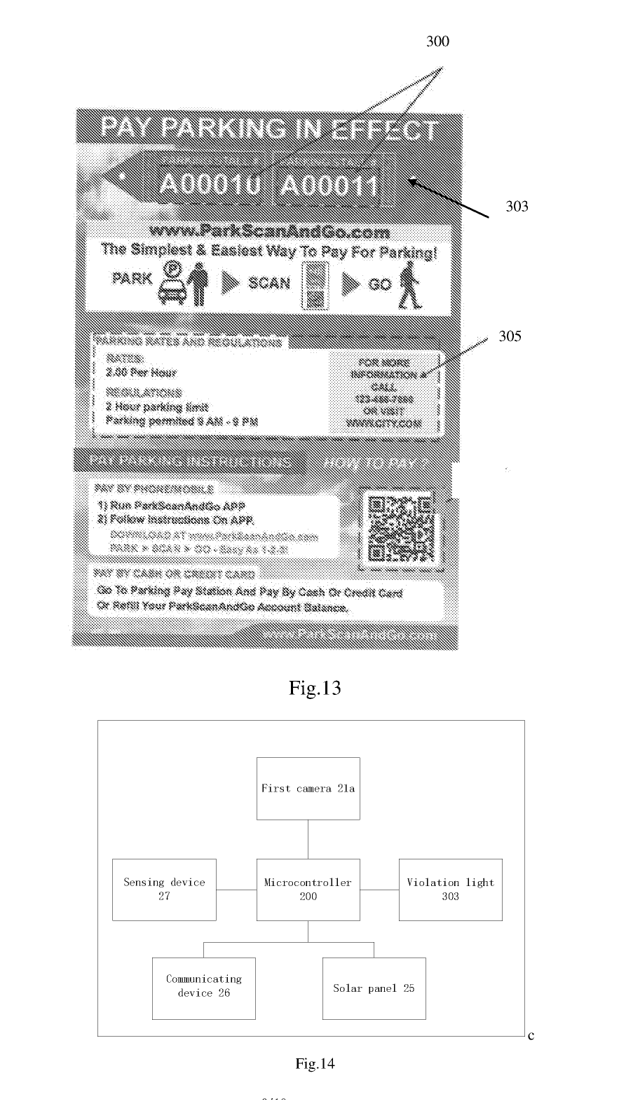

FIG. 13 illustrates a detailed example of the upper part of the parking sign. The stall number 300 is exposed on the cuboid, each of the stall number is provided with at least one violation light 303 for emitting flashing lights when vehicle violation exists. Additionally, some instructions, such as user guide 305, can also be provided on the cuboid. In this case, the picture of violation can be captured by for example the camera pucks 21b in FIG. 9 and FIG. 10. Those instructions, for example the user guide 305, may also include parking regulation, such as limited parking time or no parking/no stopping notification, etc. Moreover, the parking sign communicate with the sensor 10 embedded in the corresponding parking space and/or with the sensor included in the camera puck 21b, for enforcing such as no parking, no stopping and/or limited parking.

FIG. 14 illustrates a detailed electrical connection inside the parking sign. In this situation, the parking sign has its own microcontroller 200 for controlling other parts. A solar panel 25 is provided for converting solar energy into electricity and supplying the electricity to other parts. The first camera 21a is connected to the microcontroller for taking picture of a vehicle, and the violation light 303 is configured for emitting flashing lights to indicate any violation. Advantageously, a communicating device 26 is also connected to the microcontroller and configured for communicating the picture taken by the first camera 21a and/or it can further communicating with the sensor 10 so as to transmit the vehicle parking information. In a further embodiment, the parking sign also comprises a sensor device 27 to detect movement such as a 3 axis analog gyro sensors and/or 3 axis Accelerometer Module and/or 3 axis magnetic sensor in case the parking sign is hit or knocked over by a vehicle and/or is moved or taken without permission or because of theft/vandalism. The structure of the sensing device 27 is a very important feature as many people might try to remove the parking sign so that their car will not be detected by a sensor or photographed by the first camera on the parking sign and they may avoid paying for parking. When the sensing device 27 detects movement it can alert the central database and the authorities. It should be understood that the application of the sensing device 27 shall not be limited in the structure shown in FIG. 14, and the sensing device 27 can be included in any of the parking sign described in the present invention.

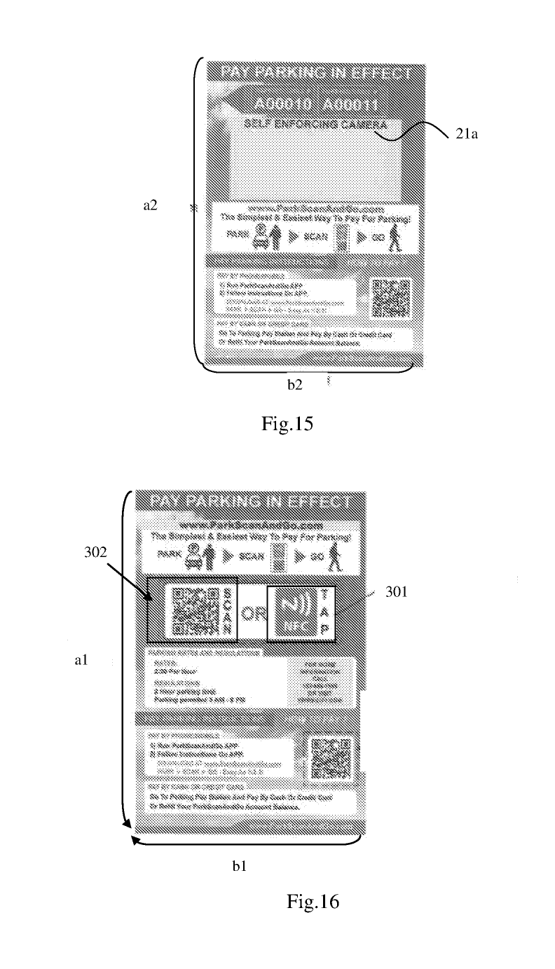

FIG. 15 illustrates a further modification of the upper part of the parking sign, which is substantially provided with a structure of a cuboid. Additionally the parking sign may be provided with a solar panel for converting solar energy into electricity. The stall number is exposed on the cuboid, each of the stall number is provided with at least with one violation light for emitting flashing lights when vehicle violation exists. The first camera 21a is also provided on the cuboid. To ensure a quick location of the parking sign, the cuboid with the stall number is preferably to have a comparatively large size. Specifically, the length is larger than 20 cm, and more precisely in this case, the length is 35 cm; the height is larger than 35 cm, and more precisely in this case, the height is 49 cm; accordingly, the thickness of the cuboid is at least 15 cm.

In a further embodiment according to the invention, the parking sign also comprises a sensing device to detect movement such as a 3 axis analog gyro sensors and/or 3 axis Accelerometer Module and/or 3 axis magnetic sensor in case the parking sign is hit or knocked over by a vehicle and/or is moved or taken without permission or because of theft/vandalism. The structure of the sensor device is a very important feature as many people might try to remove the parking sign so that their car will not be detected by a sensor or photographed by the first camera on the parking sign and they may avoid paying for parking. When the sensor detects movement it can alert the central database and the authorities.

FIG. 16 illustrates a preferred detailed example of the lower part of the parking sign, which has a similar structure with the upper part. The QR code 302 and the NFC tag, associated with the corresponding parking space, are attached on the lower part. Compared with the upper part shown in FIG. 14, the lower part is provided with a comparatively smaller size. In this case, the length is 13 cm and the height of it is 20.5 cm. This specific size is just for explanation, not for limitation.

In a preferred embodiment, all of the sensors 10 and the camera means 21a, 21b can be controlled by the server 50. The server 50 initiates a timer for a predetermined standby interval upon receiving a signal from the vehicle detection sensor 10 that a vehicle is present in the associated parking space. Then the server 50 initiates the camera means 21 to take an image of the vehicle license palate after expiry of the standby interval without receiving a signal that a payment has been made.

While, if the payment for a pre-paid parking period has been completed by the mobile device 40, the server 50 initiates a timer for the prepaid parking period upon receiving a signal that a payment has been made, and will terminate the timing of the prepaid parking period and initiates a call to the remote monitoring station as a parking violation after the expiration of the prepaid parking period without receiving a signal from the mobile device 40 that a no-fine selection that the payment of expiration time will be debited against the corresponding account automatically has been made.

During the parking period, the server 50 additionally presents a parking regulation of the parking spaces to the mobile device 40 and sends timely alarms or notifications to the mobile device 40, so as to avoid users receiving a fine ticket for later time parking or to inform the users of restricted parking for example during rush hour.

Advantageously, in case of vehicle thefts, the server 50 may send a checking reminder to the mobile device 40 for confirming, as the vehicle is moved again after parked in the parking space. Additionally, the server may also have a GPS module initiated by the communication between the mobile device 40 and the identification mark 30. The GPS module is configured for recording the location of the parking space where the vehicle is parked and presenting the mobile device a map for navigation to the vehicle, upon receiving a signal of locating the vehicle from the mobile device. For example, a request of locating the vehicle is made on the mobile device 40 and send to the server 50, for the server 50 has recorded the GPS information of the corresponding parking space, the server 50 will plan at least one path from between the present position of the mobile device and the parking space, and then the server 50 will present a map with the path to the mobile device 50. Optional, the GPS information can be stored in the QR code or in the NFC tag, once the communication between the mobile device 40 and the QR code or the NFC tag, the GPS information can be read automatically.

In all of the foregoing situations, until a violation has issued, an indicator can be displayed, such as a flashing red light, indicating to an observer that no parking violation has issued. Also as a further feature, the server will calculate whether payment is being tendered by a driver for a period when the parking spot does not permit parking, such as rush hour or beyond a maximum parking period, and refuse to accept the payment in that case or send alarm or notification to the mobile device. Again in instances where a violation has issued an indicator can be displayed, such as a flashing red light, indicating to an observer that a parking violation has issued. This will occur where the vehicle has been parked without paying, or longer than the time paid for, or beyond a maximum time or in a no-parking period or zone.

In high security locations the digital camera can automatically scan the license plate upon a vehicle being sensed, analyze the license number and compare same to a list of high risk or stolen license numbers which will then be communicated to authorities.

In the vehicle parking system, the mobile device 40, for example a cell phone, is provided with NFC function and/or QR code reading function. The mobile device 40 communicates with the identification mark 30 so as to further log in a server 50, which is provided with a payment management center. The mobile device 40 may have registered an account in the management center, so with the parking information recoded in the identification mark 30 and the logging of the mobile device, the server 50 can present payment information to the mobile device, and the driver can pay parking fees with the account.

For the first time users, once scanning the QR code or tapping the NFC tag, the mobile device will be lead to download the corresponding application program automatically. With the recognition on the QR code or the NFC tag, the application will present detailed location information, for example country, city, etc, for the user to confirm. A user may register with the system by providing a credit card authorization and cell phone number in association with the user's license plate number. After the user's registration, the user may bind his/her credit card with the registered account, and add the detailed vehicle details into the account. The driver can make a payment through the mobile device 40 by running the application after attaching the mobile device to recognizing the NFC tag or scanning the QR code. And the payment of pre-paid parking period, operation of extending parking, as well as the vehicle location and monitoring can all be presented and finished on the mobile device 40.

Should payment be made for use of associated parking space 24, the server will confirm a paying signal, terminate the timing of the standby interval and initiate the timer for a prepaid parking interval. A parking violation occurs when the operator of the vehicle either fails to make any payment or when the prepaid parking interval expires. Upon a parking violation, the server 50 activates the camera 21 and/or the camera 21b to take a digital image of the license plate of the vehicle to obtain the license number. Finally a parking violation will be sent to a communications modem notifying parking authorities, providing the vehicle identification number. In either case a parking ticket is prepared, preferably with the digital image of the vehicle license and mailed to the registered owner of the vehicle.

Conceivably, the self enforcing pay-by-phone parking system can be applied into a parking lot or garage and functions in the similar way described above.

Referring to the sheet below, a test has been made to check the performance of the sensor, especially the sensor associated with a defined parking stall.

Sheet 1

| | Group 1 | Group 2 | Group 3 | Group 4 |
|---|---|---|---|---|
| Situation | Parked exactly | Passing by the | Parked nearby | Parked partially in the stall and |
| Of the vehicles | in the stall | stall | the stall | with a wheel adjacent |
| | | | | to the sensor |
| Detecting results | Vehicle presence | no | no | no |
| (presence) | detected | | | |
| Average reaction time of | 7.4s | no | no | no |
| vehicle presence | | | | |
| Average reaction time | 6s | no | | |
| when vehicle left | | | | |

The test includes at least four groups. In the 1st, a great number of vehicles (more that 50) has been experimented to be parked right in a corresponding parking stall with then sensor of the present invention. As long as the vehicle is parked substantially in the designated area, the sensor in the stall will detect and wirelessly transmit the presence of the vehicle rapidly, with a reaction time of less than 10 s, and here in this case, the average reaction time is 7.4 s, herein the shortest reaction time detected is just 3 s. Furthermore, when the vehicle detected by the sensor was moved and driven away from the stall, the absence of the vehicle also can be detected in less than 10 s. herein, the average reaction time of absence detecting is 6 s.

In group 2, those vehicles just pass by the stall. Even though the sensor may detect magnetic change caused by some huge vehicles, like a truck, the radar detecting module can further check the parking situation, and there is no vehicle presence being detected by the sensor.

In group 3, those vehicles are just parked nearby the stall. Even in some specific experiments, the vehicle is partially parked in the stall, and adjacently to the sensor with a distance of about 10 cm, there is no vehicle presence being detected by the sensor.

Similar with groups 2-3, in group 4, those vehicles are parked partially in the stall, with a wheel adjacent to the sensor. The distance between the wheel and the sensor can be just several centimeters, such as 5 cm. There is still no vehicle presence being detected by the sensor.

According to the test above, it can be proved that the detecting accuracy of the sensor can be up to 99%,

In conclusion, the vehicle presence in the present disclosure is determined by the sensor according to a method based on magnetic field change by magnetic detecting algorithm and a radar detection as calibration of the magnetic detecting algorithm, the radar detection as a secondary detection means working in conjunction to the magnetic sensor, and thus the false detection of magnetic detection caused by the magnetic field shifts in the earth or magnetic interference/disturbance is decreased or even eliminated to a certain degree.

Furthermore, in the self enforcing pay-by-phone parking system, following advantages is further included:

the payment is accomplished through communication between a mobile device registered an account and the stall based identification mark, and then by the payment confirming from the server to the mobile device;

if the user intends to pay for parking, the operation is comparatively simple: via attaching the cell phone to the NFC tag or recognizing the QR code, phones log into the server and upload the parking information automatically; with the reorganization of registration information of the cell phone, server prompts the user to pay for the parking bill by for example entering the payment password. The payment operation is simple and convenient;

together with the more precisely detecting sensor, the camera means can timely capture the pictures of the vehicle which is involved with parking violations, avoiding interference from other vehicles, especially the large vehicles, such as a truck or the like;

the pay-by-phone parking system in the invention is stall based and is also provided with functions of theft alarming, parking regulation notification and automatically debiting against the corresponding account under the choice of the user;

compared with the parking gate or coin/cash payment parking system, the enclosed pay-by-phone system is more convenient, and provides cost-savings by reducing enforcement and meter maintenance labor, and improving revenue from self enforcement ensuring payment and from automatic zero clearing of remaining time once vehicles left;

moreover, the enclosed pay-by-phone system even help to the appearances of the roads and streets by eliminating street fixtures.

While the present invention has been described with reference to preferred embodiments, it will be understood by those skilled in the art that various changes may be made and equivalents may be substituted without departing from the scope of the present invention. But all the changes and equivalents will be included within the scope of the appended claims.

1. A vehicle presence detecting sensor associated with a defined area, wherein, the sensor comprises a microprocessor, and a first detecting module, a second detecting module, as well as a third module, respectively connected to and controlled by the microprocessor:
the first detecting module, for detecting any magnetic field change in the defined area and conveying the field change microprocessor;
the second detecting module triggered by the microprocessor when a change of magnetic field is detected, for measuring a distance between an object and the sensor by means of radar telemetering and conveying the distance to the microprocessor;
the third module triggered by the microprocessor when the distance measured falls out of a pre-determined distance range, for further detecting the change of magnetic field and conveying a detailed change of magnetic field to the microprocessor;
the microprocessor, for activating the second detecting module when a change of magnetic field is detected by the first detecting module or activating the third module when the distance measured falls out of the pre-determined distance range, and for conforming the presence of a vehicle by comparing the distance measured by the second detecting module with the predetermined distance range, or by matching the value of the detailed change of magnetic field detected by the third module, with pre-stored values.

2. The vehicle presence detecting sensor according to claim 1, wherein, the sensor also comprises a saving module triggered by the microprocessor, for saving the magnetic field change detected by the first detecting module, when the distance measured falls into of the pre-determined distance range.

3. The vehicle presence detecting sensor according to claim 2, wherein, the sensor also comprises a rest module triggered by the microprocessor, for leading the sensor into a rest mode for a defined period when the presence of a vehicle is determined or no change of magnetic field is detected first detecting module.

4. The vehicle presence detecting sensor according to claim 1, wherein, a further predetermined range is configured for the second detecting module 12 to detect a tampering with the sensor.

5. The vehicle presence detecting sensor according to claim 4, wherein, the sensor is an in-ground sensor, and the predetermined distance range is 10 cm-100 cm, and the further predetermined range is 0-9.99 cm.

6. The vehicle presence detecting sensor according to claim 4, wherein, the sensor is provided with an shell that having an upper part as well as a lower part embedded, and the upper part is of a circular arc profiles.

7. The vehicle presence detecting sensor according to claim 1, wherein, the sensor also comprises a communication module, by means of which the information of vehicle presence is transmitted outward.

8. The vehicle presence detecting sensor according to claim 1, wherein, the communication module is operated in either wired or wireless mode.

9. The vehicle presence detecting sensor according to claim 2, wherein, the sensor also comprises an imaging module triggered by the microprocessor, for taking a picture of the vehicle present in the defined area.

10. The vehicle presence detecting sensor according to claim 9, wherein, the sensor also comprises a lighting module connected to the imaging module and configured for providing illumination to the imaging module in dark environments.

11. The vehicle presence detecting sensor according to claim 1, wherein, the sensor also comprises a power module, for providing power energy for the microprocessor and further for the other modules.

12. The vehicle presence detecting sensor according to claim 11, wherein, the power module is a battery or a solar panel.

13. The vehicle presence detecting sensor according to any of claims 1-12, wherein, the sensor also comprises a further sensing element to detect movement such as a 3 axis analog gyro sensors and/or 3 axis accelerometer module and/or a 3 axis magnetic sensor in case the sensor is moved or taken without permission or because of theft/vandalism.

14. A method for detecting vehicle presence by means of the vehicle presence detecting sensor claimed in any of claims 1-13, comprising:
magnetic detecting step: detecting any magnetic field change in the defined area;
radar determining step: measuring a distance between an object and the sensor by means of radar telemetering and determining the presence of a vehicle by comparing the distance measured with a predetermined distance range, when a change of magnetic field is detected;
and a further detecting step: further detecting the change of magnetic field and matching the value of the detected change of magnetic field with pre-stored values so as to determine the presence of a vehicle, when the distance measured falls out of the pre-determined distance range.

15. The method of claim 14, wherein, the Radar determining step further includes steps that:
if the distance measured by the sensor falls into the predetermined distance range, the vehicle presence is determined;
if the distance measured falls out of the predetermined distance range, the further detecting step is carried out.

16. The method of claim 14, wherein, the method further comprises a resting step that the sensor turns into a resting mode for a defined period when no magnetic field change is detected or presence of a vehicle is confirmed either in radar determining step or the further detecting step.

17. The method of claim 15,wherein, if the distance measured by the sensor falls into the predetermined distance range, the method further comprising steps of saving the detected magnetic field change.

18. A self enforcing pay-by-phone parking system, controlling a plurality of parking spaces, characterized in comprising:
a plurality of vehicle detecting sensor claimed in one of the claims 1-13, each associated with one of the parking spaces for detecting the presence or absence of a vehicle in the parking space, for communicating a signal indicative of the presence or absence of a vehicle in the one of the parking spaces;
a plurality of camera means each associated with one of the parking spaces and each adapted to be focused at the one of the parking spaces in the area of the parking space where the license plate of a parked vehicle is located, for communicating a digital image of the license plate of a parked vehicle;
and a unique identification mark associated with each parking space, for recording information of a vehicle parked in the parking space,
wherein the payment is accomplished through communication between a mobile device with a registered account and the identification mark, and then by the payment confirming of a pre-paid parking period from the server to the mobile device.

19. The self enforcing pay-by-phone parking system of claim 18, wherein the system comprises communicating means for providing communication access for the server. sensor, identification mark and/or the camera means.

20. The self enforcing pay-by-phone parking system of claim 18, wherein the system further comprises an account refill station for checking account information of the mobile device and refill money into the account.

21. The self enforcing pay-by-phone parking system of claim 18, wherein, wherein the identification mark includes a stall number as well as a NFC tag and/or a QR code.

22. The self enforcing pay-by-phone parking system of claim 21, wherein, the identification mark is attached on free-standing above ground, or the system further comprises a parking sign arranged adjacently to the corresponding parking space, on which the stall number is exposed on top of the parking sign, and the NFC tag and/or QR code on a lower part of the parking sign.

23. The self enforcing pay-by-phone parking system of claim 22, wherein, two adjacent parking spaces share the same parking sign.

24. The self enforcing pay-by-phone parking system of claim 22, wherein, the camera means includes a first camera provided on the top of the parking sign, for taking a picture of the vehicle.

25. The self enforcing pay-by-phone parking system of claim 24, wherein, the parking sign is provided with violation lights, for emitting flashing lights for indicating vehicle violations.

26. The self enforcing pay-by-phone parking system of claim 25, wherein, the camera means includes a in-ground camera puck embedded in ground for taking a picture of the license plate of a parked vehicle.

27. The self enforcing pay-by-phone parking system of claim 26, wherein, the in-ground camera puck is placed in a no-parking region adjacent to each of the parking spaces, and the camera puck is provided two cameras with two opposite shooting directions each focusing on the respective license plate of two adjacent vehicles.

28. The self enforcing pay-by-phone parking system of claim 27, wherein, the parking space individually has its own no parking region, and/or two adjacent parking spaces share the same no parking region, which is a designated area between stalls of the front and/or rear of the parked vehicle to improve and ensure the capture of the vehicle's license plate with the camera.

29. The self enforcing pay-by-phone parking system of claim 28, wherein, the parking sign is provided with a solar panel for converting solar energy into electricity.

30. The self enforcing pay-by-phone parking system of claim 22, wherein, the server initiates the timer for a predetermined standby interval upon receiving a signal from the vehicle detection sensor that a vehicle is present in the associated parking space, wherein the server initiates the camera means to take an image of the vehicle license palate after expiry of the standby interval without receiving a signal that a payment has been made.

31. The self enforcing pay-by-phone parking system of claim 30, wherein, the server initiates the timer for a prepaid parking period upon receiving a signal that a payment has been made, the server is adapted to terminate the timing of the prepaid parking period and initiates the camera on the parking sign or the in ground camera puck to take a picture of the vehicle as a parking violation after the expiration of the prepaid parking period without receiving a signal from the mobile device that a no-fine selection that the payment of expiration time will be debited against the corresponding account automatically has been made.

32. The self enforcing pay-by-phone parking system of claim 31, wherein, before the parking violation is assured, a post-grace period is also provided after the expiration of the prepaid parking period for the user to make payment for extending the parking time.

33. The self enforcing pay-by-phone parking system of claim 22, wherein, the server presents a parking regulation of the parking spaces to the mobile device and sends timely alarms or notifications to the mobile device.

34. The self enforcing pay-by-phone parking system of claim 22, wherein, in case of vehicle thefts, the server sends a checking reminder to the mobile device for confirming, as the vehicle is moved again after parked in the parking space.

35. The self enforcing pay-by-phone parking system of claim 22, wherein, the server has a GPS module initiated by the communication between the mobile device and the identification mark, for recording the location of the vehicle and presenting the mobile device a map for navigation to the vehicle, upon receiving a signal of locating the vehicle from the mobile device.

36. The self enforcing pay-by-phone parking system of any of claims 22-35, wherein, the parking sign also comprises a sensor device to detect movement such as a 3 axis analog gyro sensors and/or 3 axis Accelerometer Module and/or 3 axis magnetic sensor in case the parking sign is hit or knocked over by a vehicle and/or is moved or taken without permission or because of theft/vandalism.

37. The self enforcing pay-by-phone parking system of any of claims 26-29, wherein, the camera puck is also provided with the vehicle presence detecting sensor inside, so as to detect whether any vehicle is parked over the camera puck.

38. The self enforcing pay-by-phone parking system of claim 37, wherein, the parking sign communicate with the sensor associated with the parking space or the sensor in the camera puck, so as to enforce no parking with the sensor in the camera puck or enforce limited parking with the sensor associated with the parking space.
